(19) United States
(12) Patent Application Publication
(10) Pub. No.: US 2023/0084853 A1
(43) Pub. Date: Mar. 16, 2023

(54) MALE MASTURBATION DEVICE

(71) Applicant: INNOVATION STREET PTE. LTD., Singapore (SG)

(72) Inventor: Praveen RAJU, Singapore (SG)

(21) Appl. No.: 17/472,245

(22) Filed: Sep. 10, 2021

(51) Int. Cl. A61H 19/00; A61H 23/00

(52) U.S. Cl. CPC A61H 19/32; A61H 23/00; A61H 2201/0207

(57) ABSTRACT

A male masturbation device, includes a soft artificial colloid set in a housing which imitates the vagina, and a cavity is provided in the artificial colloid for accommodating the penis; a vibration device is embedded in the colloid for stimulating the penis. The vibration device can be activated according to needs of the user. And the modes of vibrations can be change by user selection and transmitted to penis by the artificial colloid. Let user experience a more realistic effect and better stimulate the male reproductive organs and achieve orgasm.

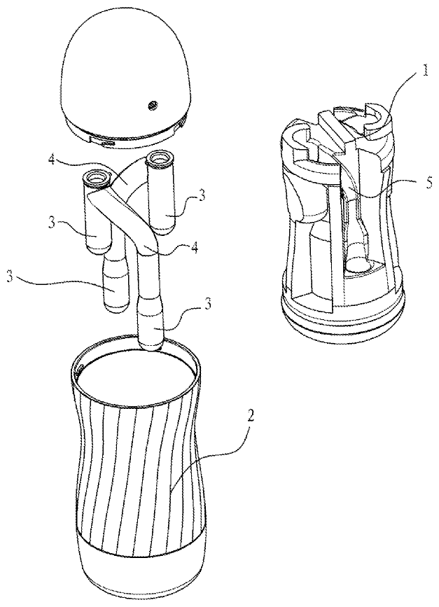

### FIELD OF THE INVENTION

The Utility Model involves a sex product, especially a mal masturbation device.

### BACKGROUND OF THE INVENTION

Masturbation has the merit of independent sexual behavior, and can obtain the same physiological response as sexual intercourse. Appropriate masturbation will not cause any harm to the body, but can also make up for people who cannot have sex in life, such as unmarried young people, separated husbands and wives, divorced widows, STD patients, disabled persons, and spouses who are sick and cannot have sex. And masturbation give them greater enthusiasm and energy for work. Further, masturbation can also be used to collect semen samples for clinical examination, and healthy men can also donate their own semen through masturbation. Masturbation will not cause any sexual infectious disease, will not involve others, or be involved in infidelity in sexual behavior and emotional entanglement, and will help to decrease sexual assault or even sexual crimes, and avoids moral and social problems caused by sexual problems. Therefore, masturbation is harmless. Do not have psychological pressure to avoid feelings of guilt and self-blame. But frequent masturbation may lead to lack of concentration, fatigue, and memory loss. Therefore, it is necessary to control the frequency and intensity of masturbation

In order to meet the demand of masturbation, there are masturbation devices for men on the market. Most of the existing male masturbators are made of soft rubber to simulate the female vagina and add a vibration function to produce a stimulating effect. However, due to the simple structure and relatively single function, it is difficult to imitate the various stimuli produced during human sexual behavior, so it is not ideal.

### SUMMARY OF THE UTILITY MODEL

In view of the aforesaid drawbacks of the prior art, the present utility model provides a male masturbation device to imitate the movement of female vagina, and let it feel more realistic when used, so as to better stimulate male reproductive organs and achieve orgasm.

So, the utility model provides:

A male masturbation device, includes a soft artificial colloid set in a housing which imitates the vagina, and a cavity is provided in the artificial colloid for accommodating the penis; a vibration device is embedded in the colloid for stimulating the penis.

Further, the vibration device is installed and sealed in an elastic pipe to let the vibration device extend from the controller to the embedded position of the colloid.

Further, the artificial colloid provides a groove for installation of each elastic pipe.

Further, the number of the vibration devices is 2 or more; each vibration device is installed in an elastic pipe and embedded in different position of the colloid.

Further, several elastic pipes grouped in to one pipe assembly, which includes the short pipe and the long pipe; the short pipe sets the vibration device to the top position of the colloid and the long pipe sets the vibration device to the bottom position.

Further, a heating device is provided and set together with the vibration device.

Further, the vibrating device is a vibrating motor, the motor is wrapped with a heating sheet, and the motor and the heating sheet are covered with the elastic pipe outside.

The utility model has the following advantages: the vibration device can be activated according to needs of the user. And the modes of vibrations can be change by user selection and transmitted to penis by the artificial colloid. Let user experience a more realistic effect and better stimulate the male reproductive organs and achieve orgasm.

### BRIEF DESCRIPTION OF THE DRAWINGS

Below are explanations of the invention combining with drawings.

The sole FIGURE is the exploded view of the present utility model.

In the FIGURES: 1. the colloid, 2. the housing, 3. the vibration device, 4. the elastic pipe, 5. the groove.

### DESCRIPTION OF THE EMBODIMENTS

Refer to the sole FIGURE, the male masturbation device includes a soft artificial colloid 1 set in a housing 2 which imitates the vagina, and a cavity is provided in the artificial colloid 1 for accommodating the penis. The artificial colloid 1 generally uses the silicone which simulates the skin, to be solidified and formed by a mold. And it imitates the structure of a female vagina, making the artificial colloid 1 close to the female vagina by touch and practicality. The vibration device 3 is embedded in the colloid 1 and can be activated according to needs of the user. When it is activated, the vibration is transmitted to penis by the artificial colloid 1, so that lets user experience a more realistic effect and better stimulate the male reproductive organs and achieve orgasm.

The vibration devices 3 are controlled by a controller for user activating/deactivating the devices or changing the vibration modes. Each vibration device 3 connects to the controller by wires. For protecting the wires and the vibration device 3 from damage while disassembling the colloid 1, the vibration device 3 is installed and sealed in an elastic pipe 4. One reason is that let the vibration device 3 extend from the controller to the embedded position of the colloid 1. Another is that the elastic pipe 4 can be easily bended and inserted into the colloid 1.

For limiting the installation path of elastic pipe 4 to avoid the vibration transmitting to the housing 2 and make noise, the artificial colloid 1 provides a groove 5 for installation of each elastic pipe 4.

The number of the vibration devices 3 is two or more. Each vibration device 3 connects to the one output port of the controller for individual control of every vibration device 3. And each vibration device 3 embedded in different position of the colloid 1, so that user can individually activate the needed vibration device 3 to have difference experience. For more easy installation of several vibration devices 3, several elastic pipes 4 grouped in to one pipe assembly. Each pipe assembly includes the short pipe and the long pipe. The short pipe sets the vibration device 3 to the top position of the colloid 1 and the long pipe sets the vibration device 3 to the bottom position.

The vibration device 3 can be activated according to needs of the user. There are many kinds of devices on the market which can achieve vibrations, and the modes of vibrations are also different, such as rotation, swing, movement, etc. The vibration can be combined with the contraction and expansion of the colloid 1 to form more complex diverse experience. The utility model is preferably using a vibrating motor, which can simplify the structure. The heating device can heat up the colloid 1 to let user feel like a real vagina and avoid bad experience of too low temperature.

1. A male masturbation device, wherein includes a soft artificial colloid (1) set in a housing (2) which imitates the vagina, and a cavity is provided in the artificial colloid (1) for accommodating the penis; a vibration device (3) is embedded in the colloid (1) for stimulating the penis.

2. The male masturbation device of claim 1, wherein the vibration device (3) is installed and sealed in an elastic pipe (4) to let the vibration device (3) extend from the controller to the embedded position of the colloid (1).

3. The male masturbation device of claim 2, wherein the artificial colloid (1) provides a groove (5) for installation of each elastic pipe (4).

4. The male masturbation device of claim 2, wherein the number of the vibration devices (3) is two or more; each vibration device (3) is installed in an elastic pipe (4) and embedded in different position of the colloid (1).

5. The male masturbation device of claim 3, wherein several elastic pipes (4) grouped in to one pipe assembly, which includes the short pipe and the long pipe; the short pipe sets the vibration device (3) to the top position of the colloid (1) and the long pipe sets the vibration device (3) to the bottom position.

6. The male masturbation device of claim 1, wherein a heating device is provided and set together with the vibration device (3).

7. The male masturbation device of claim 6, wherein the vibrating device is a vibrating motor, the motor is wrapped with a heating sheet, and the motor and the heating sheet are covered with the elastic pipe (4) outside.
